(19) United States
(12) Patent Application Publication
(10) Pub. No.: US 2024/0157944 A1
(43) Pub. Date: May 16, 2024

(54) REINFORCEMENT LEARNING FOR AUTONOMOUS LANE CHANGE

(71) Applicant: Baidu USA LLC, Sunnyvale, CA (US)

(72) Inventors: ZHAN SHI, Sunnyvale, CA (US); YIFEI JIANG, Sunnyvale, CA (US); ANG LI, Sunnyvale, CA (US)

(21) Appl. No.: 17/985,677

(22) Filed: Nov. 11, 2022

(51) Int. Cl. B60W 30/18; B60W 50/00; B60W 60/00; G05B 13/02

(52) U.S. Cl. CPC B60W 30/18163; B60W 50/0098; B60W 60/001; G05B 13/027; B60W 2050/0022; B60W 2520/10; B60W 2552/10; B60W 2554/4042; B60W 2554/802; B60W 2710/207; B60W 2720/106

(57) ABSTRACT

In one embodiment, a system determines a target lane for an autonomous driving vehicle (ADV) to change lanes from a current lane to the target lane. The system determines obstacles information for one or more obstacles surrounding the ADV from sensor data. The system determines vehicle information of the ADV including a speed of the ADV. The system applies a reinforcement learning (RL) model to the obstacles and vehicle information of the ADV to generate an action for the ADV, where the action includes an acceleration/deceleration value and a steering angle value. The system controls the ADV to perform the lane change from the current lane to the target lane by executing the action.

### TECHNICAL FIELD

Embodiments of the present disclosure relate generally to operating autonomous driving vehicles. More particularly, embodiments of the disclosure relate to reinforcement learning for autonomous lane change that is used by autonomous driving vehicles (ADVs).

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Motion planning and control are critical operations in autonomous driving. Motion planning and control includes lane change to maneuver the ADV from one lane to a target lane. Lane change allows an ADV to stay on a lane with a smooth traffic flow or to enter/exit a roadway. For example, for a three lane driveway, an ADV lane change to a middle lane usually allows the ADV to operate a smoothest driving. When an ADV is required to maneuver slower than the traffic, enter or exit the roadway, or move to the road curb, the ADV can change to the right lane.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram illustrating an example of a machine learning engine according to one embodiment.

FIG. 5 is a block diagram illustrating an example of a lane change module according to one embodiment.

FIG. 6A is a block diagram illustrating reinforcement learning according to one embodiment.

FIG. 6B is a block diagram illustrating an example algorithm to train a deep Q network using reinforcement learning according to one embodiment.

FIG. 7 is a block diagram illustrating an example of a multilayer perceptron according to one embodiment.

FIG. 8 is a block diagram illustrating a plurality of rays representative of obstacles information according to one embodiment.

FIG. 9 is a flow diagram illustrating a process to train a ML model using RL according to one embodiment.

FIG. 10 is a flow diagram illustrating a process to perform a lane change using an RL agent according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, a reinforcement learning (RL) approach is used to perform lane changes. A RL model is applied to information for obstacles surrounding an ADV and a status of the ADV. The RL model outputs acceleration/deceleration and steering angle value to guide the ADV to a location for lane change and guides the ADV to complete the lane change.

Previously, a dynamic programming algorithm is used to solve an optimization problem for lane changes. For example, in each planning cycle, when an ADV requires a lane change, a lane change algorithm considers all possible control actions (e.g., accelerate, decelerate, steering angle) to decide when and where to perform a lane change for the ADV. However, the dynamic programming approach is computationally inefficient because it iterates over all possible actions (iterate over each amount of acceleration, deceleration, steering angle, etc.) at each planning cycle. Second, the approach is memory inefficient because the optimization problem is required to be solved as sub-problems, and intermediate solutions for the sub-problem are stored for the optimization.

The decision and planning of lane change for an autonomous vehicle can be decomposed into at least a preparation phase and a lane change phase. The preparation phase for the autonomous vehicle can maneuver the ADV within a current lane with varying speeds and the lane change phase can maneuver the ADV towards a target lane. In one embodiment, a reinforcement learning model outputs an acceleration/deceleration value and steering angle for ADVs to execute a complete lane change. Specifically, at preparation phase, the ADVs follows the acceleration/deceleration output and steering angle (in this phase, steering angle should be hardly changed) to reach a suitable location for lane change, i.e., appropriate relative distance and relative speeds to both front cars and rear cars in the target lane. At lane change phase, the ADVs follows the acceleration/deceleration output and steering angle to complete the lane change.

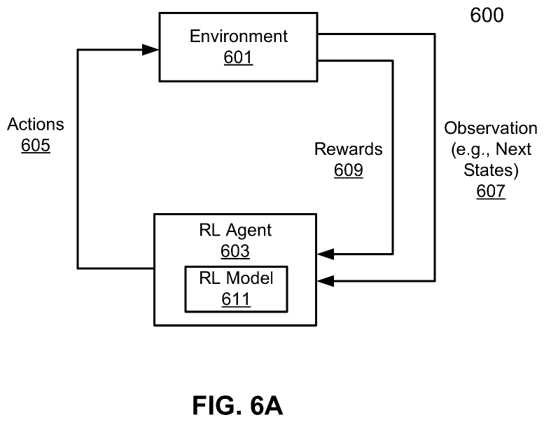

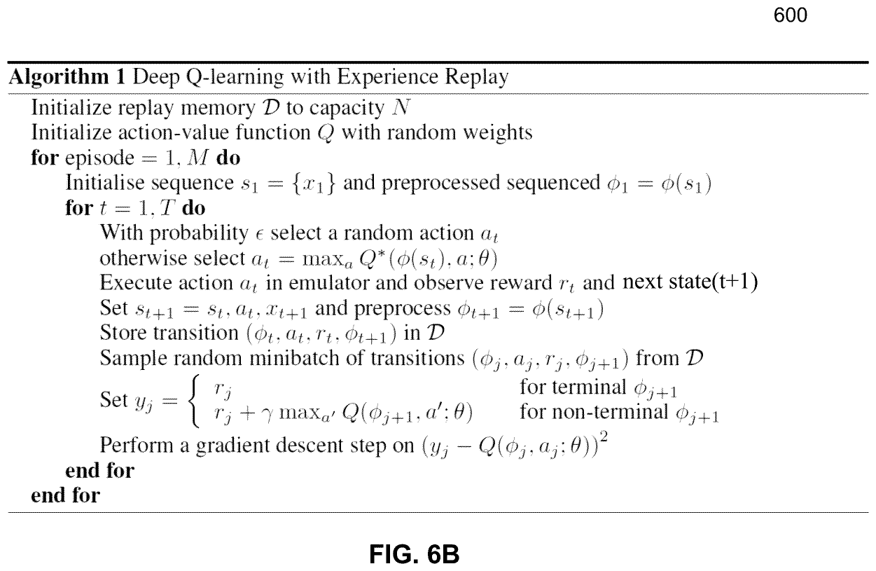

According to a first aspect, a system provides a driving simulation environment to train a reinforcement learning (RL) agent for an autonomous driving vehicle (ADV). The system trains the RL agent in the driving simulation environment, including applying a RL model of the RL agent to obstacles information and vehicle information of the ADV to determine a plurality of Q values corresponding to a plurality of actions in an action space for the ADV, where an action includes acceleration/deceleration and steering angle. The training includes executing an action correspond to a highest Q value from the plurality of Q values to determine a next state of the ADV, determining a total reward based on the reward calculated for the next state and a discounted future reward for possible future actions of the ADV. Then the algorithm updates the weight parameters of the RL model based on the squared temporal difference between total reward and the estimated total reward calculated by Q network as in FIG. 6B. Finally, the RL model is used to determine an action for the ADV to perform a lane change.

According to a second aspect, a system determines a target lane for an autonomous driving vehicle (ADV) to change lanes from a current lane to the target lane. The system determines, from sensor data, obstacles information for one or more obstacles surrounding the ADV. The system determines vehicle information including a speed of the ADV. The system applies a reinforcement learning (RL) model to the obstacles information and the vehicle information of the ADV to generate an action for the ADV, where the action comprises acceleration/deceleration and steering angle. The system controls the ADV to perform the lane change from the current lane to a target lane by following the action.

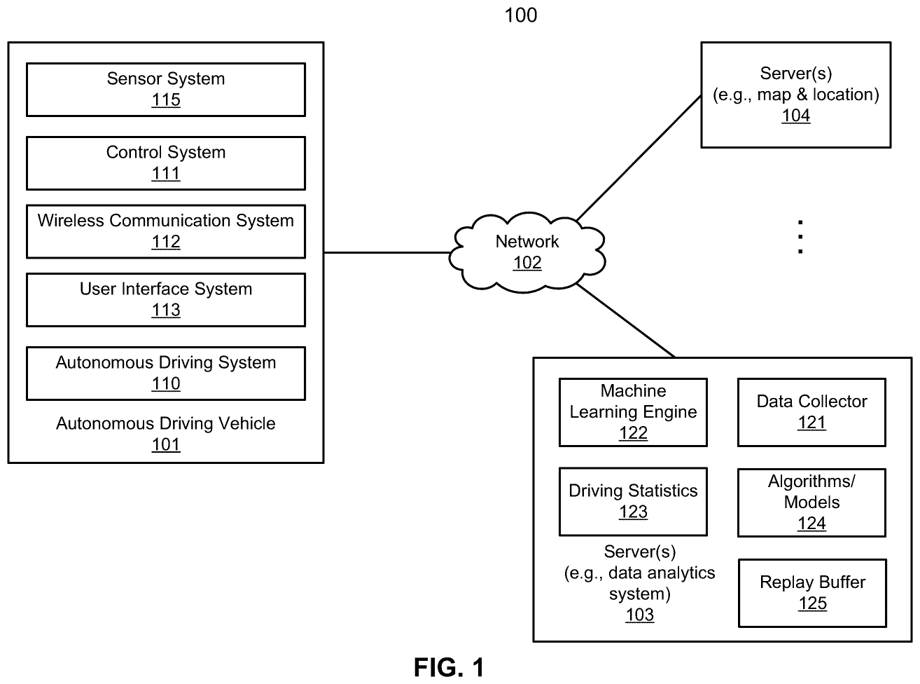

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

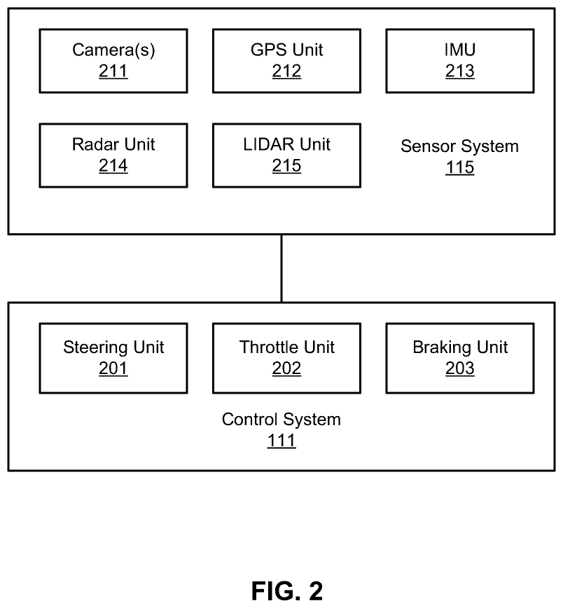

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

Server 103 may be a data analytics system to perform data analytics services for a variety of clients. In one embodiment, data analytics system 103 includes data collector 121 and machine learning engine 122. Data collector 121 collects driving statistics 123 from a variety of vehicles, either ADVs or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), WIPOIs, road conditions, weather conditions, etc.

Based on driving statistics 123, machine learning engine 122 generates or trains a set of rules, algorithms, and/or predictive models 124 for a variety of purposes. In one embodiment, algorithms 124 may include a reinforcement learning (RL) model with a RL agent that can decide when and where to perform a lane change. The RL agent can be trained using a value-based RL algorithm (e.g., DQN algorithm). An example of a value-based RL algorithm can include a deep Q-network (DQN) that approximates an action-state value function in a Q learning framework. The deep Q network (or RL model) can include a multilayer perceptron (MLP) or the like. The deep Q network can calculate a future expected reward for a particular state of the vehicle. In one embodiment, the RL agent can generate experience replays and store the replays in replay buffer 125 for training as further described in FIGS. 6A-6B.

Algorithms 124 can then be uploaded on ADVs to be utilized during autonomous driving in real-time.

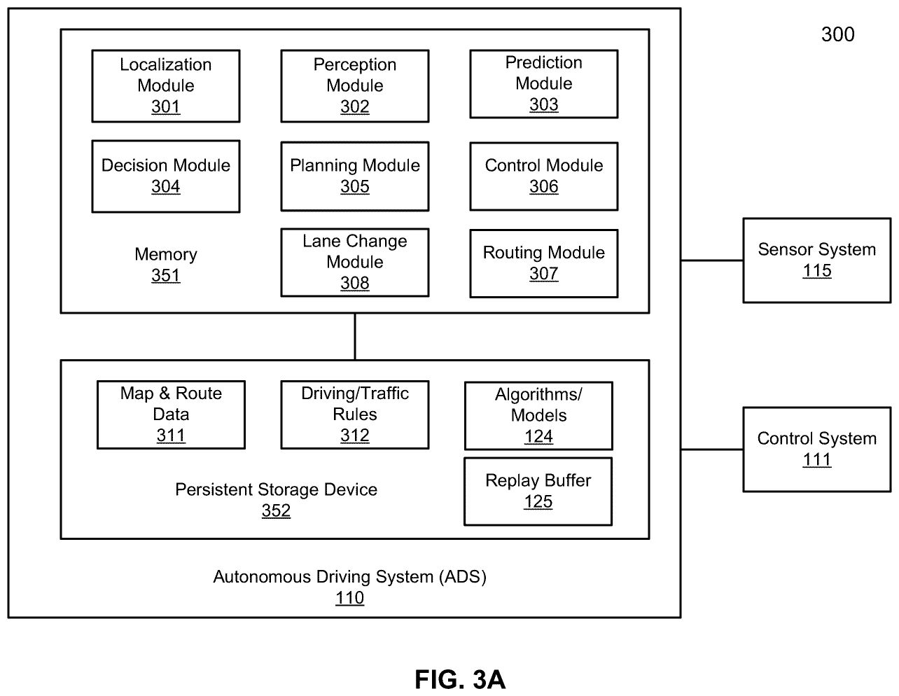

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, routing module 307, lane change module 308.

Some or all of modules 301-308 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-308 may be integrated together as an integrated module.

Localization module 301 determines a current location of ADV 101 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 101, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 101 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

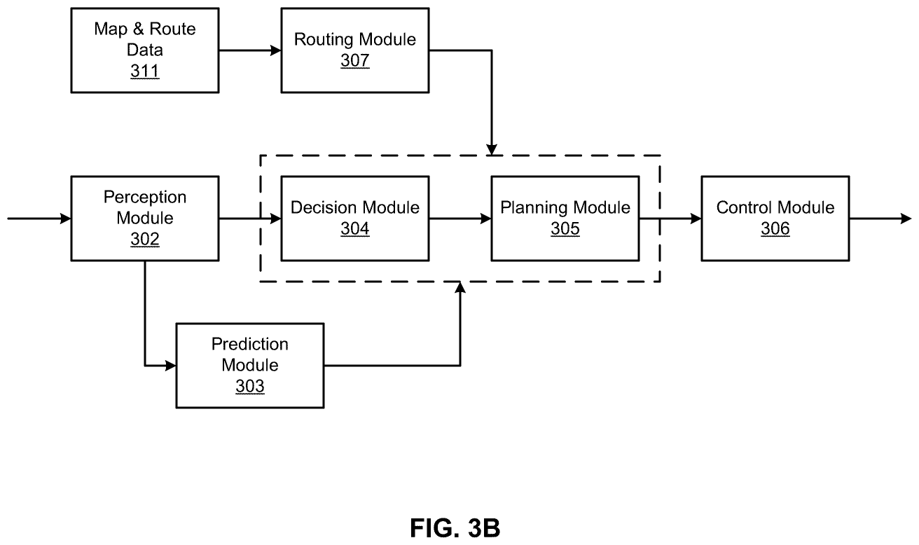

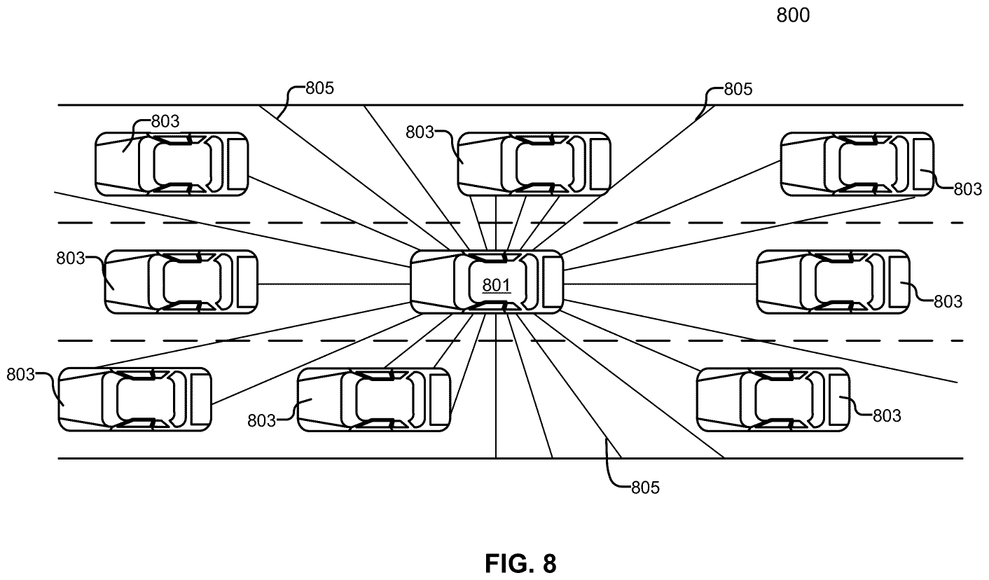

FIG. 4 is a block diagram illustrating an example of a machine learning engine according to one embodiment. Machine learning (ML) engine 122 can train a machine learning (reinforcement learning) model for a lane change module of an ADV. In one embodiment, ML engine 122 includes submodules such as simulation environment provider 401, RL agent trainer 402, obstacles information determiner 403, vehicle information determiner 404, action space determiner 405, Q-value determiner 406, rewards determiner 407, and RL model updater 408. Simulation environment provider 401 can provide a driving simulation environment for reinforcement learning. For example, a simulation environment can be a two-dimensional (2D) or 3D environment that physically models different driving scenarios with vehicle dynamics for an ADV. An example driving simulation environment is shown in FIG. 8.

RL agent trainer 402 can include a trainer that trains an RL agent. RL agent trainer can step through episodes of training scenarios for an RL agent to learn by trial and error. Obstacles information determiner 403 can determine obstacles information for an ADV as part of the state information for the RL algorithm. Obstacles information can include information about obstacles perceived by sensors of an ADV, such as a distance to a vehicle in front of the ADV, a distance to a vehicle behind the ADV, or a length of a gap between two vehicles at a target lane. In one embodiment, obstacles information can be represented by a plurality for distance and/or velocity rays irradiated from the ADV. The rays can measure distances (and/or velocity) to surrounding obstacles for the ADV. For example, the distance rays can measure distances to obstacles that are detectable by sensors of the ADV. The velocity rays can measure an approximate velocity for the detected obstacles. In one embodiment, a ray vector can be (x, y, sqrt((x−x₀)²+(y−y₀)²), speed), where (x, y) is a coordinate of a reflection from a detected obstacle, (x₀, y₀) is a coordinate of the ADV, sqrt((x−x₀)²+(y−y₀)²) is a distance from the ADV to the detected obstacle, and speed is an approximate velocity of the detected obstacle.

Vehicle information determiner 404 can determine information about the vehicle as part of the state information. Vehicle information can include a heading direction and/or velocity of the ADV. Action space determiner 405 can determine the action space for the RL agent. For example, an action space can be: acceleration, deceleration, and/or a steering angle. Values for the actions in the action space can be discretized. For example, steering angle can be discretized to increments of 5 degrees, etc. Q-value determiner 406 can apply a value-based RL model to a current state (vehicle and obstacles information) of the ADV to calculate a plurality of values (e.g., Q-values). The plurality of values can correspond to a plurality of possible control actions (accelerate, decelerate, steering angle, etc.) for the ADV. Rewards determiner 407 can determine a reward for a state of the ADV. A positive reward can be preset for the simulation environment for some positive driving behaviors (e.g., a successful lane change). For example, the RL agent completing a lane change can be provided a reward of +10. A negative reward can be set for the simulation environment for negative driving behaviors. For example, a −1 reward can be assigned for the ADV being in a blind spot of an obstacle vehicle, for collision in the traffic, for causing the traffic to slowly down, etc. During simulation, RL trainer loops through episodes of driving scenarios for the vehicle to act out one or more actions according to a maximum value from a Q-network or randomly act out an action. RL model updater 408 can update parameter weights/biases of the Q-network accordingly if the RL agent achieves a high reward. Through many replay scenarios, Q-network is trained to select actions that are rewarding. Note that some of modules 401-408 may be integrated together as an integrated module.

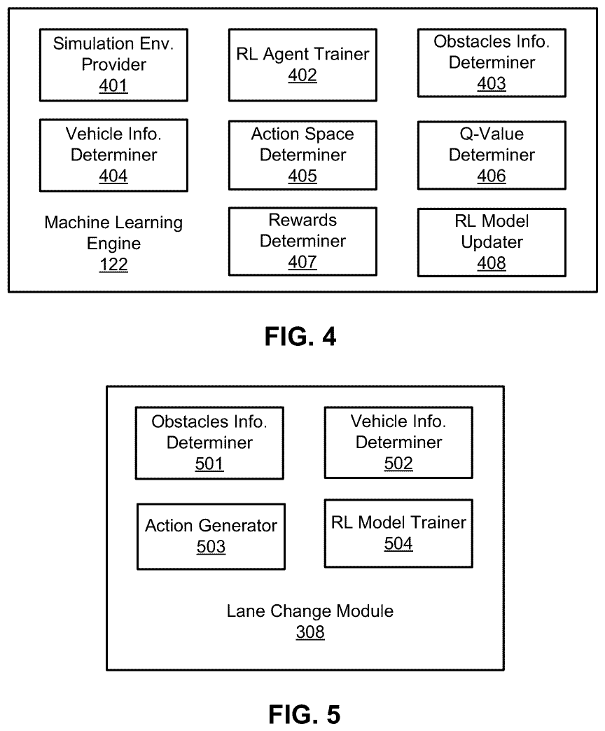

FIG. 5 is a block diagram illustrating an example of a lane change module according to one embodiment. Lane change module 308 can execute online to guide ADV 101 to perform a lane change. In one embodiment, lane change module 308 includes submodules such as obstacles information determiner 501, vehicle information determiner 502, action generator 503, and RL model trainer 504. Obstacles information determiner 501 can determine obstacles information for an ADV as part of state information for the RL algorithm. As described above, obstacles information can include information about obstacles perceived by sensors of an ADV, such as a distance to a vehicle in front of the ADV, a distance to a vehicle behind the ADV, or a length of a gap between two vehicles at a target lane. The obstacles information can be represented by a plurality for distance and/or velocity rays radiated from the ADV. The distance rays can measure distances to obstacles that are detectable by sensors of the ADV and the velocity rays can measure an approximate velocity of the detected obstacles.

Vehicle information determiner 502 can determine information about the vehicle as part of the state information. Vehicle information can include a heading direction and/or velocity of the ADV. Action generator 503 can generate an action for the ADV. The generated action can correspond to an action with a best Q-value (best expected future rewards) from the current state information of the ADV. An example action can indicate whether to accelerate, decelerate, or apply a steering angle to maneuver/control the ADV. The action can be executed by the ADV for a current planning cycle to control the ADV.

RL model trainer 504 can train the RL agent online using experience replays stored in a replay buffer, such as replay buffer 125 of FIG. 3A. Note that some of modules 501-504 may be integrated together as an integrated module.

FIG. 6A is a block diagram illustrating reinforcement learning according to one embodiment. Reinforcement learning is an unsupervised ML learning based on rewarding desirable behaviors and/or punishing undesirable behaviors. RL model 600 can be part of algorithms/models 124 of FIG. 3A. Referring to FIG. 6A, RL model 600 can include RL agent 603. RL agent 603 can perceive and interpret a predefined environment 601, take actions 605 and learn through interactions with environment 601. RL agent 603 can include a RL model 611 (e.g., Q network). In one embodiment, the RL model includes a multilayer perceptron (MLP) neural network model. For example, environment 601 can have predefined rewards 609 for particular actions and take an action 605 to obtain a next state 607. Environment 601 can represent a real physical world or a simulation environment for the ADV.

In summary, desirable behaviors are assigned positive rewards to encourage RL agent 603 to take desirable behaviors. Undesirable behaviors are assigned negative rewards to discourage RL agent 603 from taking undesirable behaviors. RL agent 603 can then seek long-term maximal rewards to achieve an optimal solution. Through numerous learning iterations, RL agent 603 can learn to avoid negative behaviors and seek positive behaviors.

FIG. 6B is a block diagram illustrating an example algorithm 600 to train a deep Q network using reinforcement learning according to one embodiment. As described above, algorithm 600 can receive state information (obstacles and vehicle information) as inputs to generate a vector of Q-values. The indices for the vector of Q-values can correspond to a plurality of actions and an index value for the highest Q-value can be selected corresponding to an optimal action. Further, to mitigate catastrophic forgetting, an experience replay buffer 125 is used to store a predetermined number of replays (e.g., current state, current action, reward, next state, next action) to train the MLP at a predetermined periodic interval.

Referring to FIG. 6B, deep Q learning algorithm 600 initializes a replay buffer 124 with a predetermined capacity N and initializes an action-value Q function (or Q network (e.g., MLP 611)) with random weights, where N is a quantity of replay experiences. The outer loop of algorithm 600 step through one or more replay episodes. For the inner loop, an action is selected either randomly or as an optimal action from the Q-function for execution. The environment executes the action and the RL agent observes the environment to determine a reward and a next state for the RL agent. A total reward is determined as a sum of the determined reward for the current state and discounted future rewards that is possible from the current state.

In one embodiment, a predetermined random number of sample experiences are selected from the N experiences to update the Q network periodically to prevent catastrophic forgetting. In one embodiment, a copy of the Q network is updated (e.g., weight/bias parameters) batch-wise, instead of the Q network of the RL agent, and the updated weights/bias are copied to the original Q network at a predetermined period to prevent divergence. Then, through trial and error, Q network 603 can be updated with weights/bias values that selects actions to maximize future rewards.

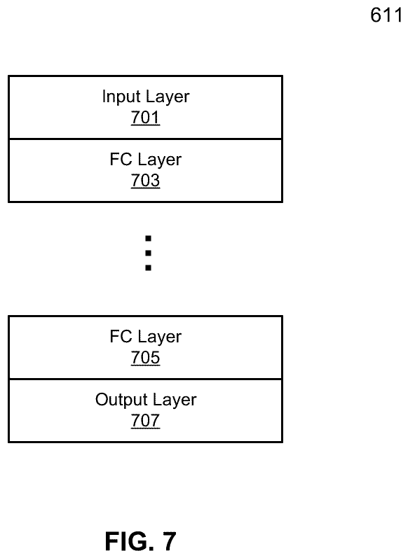

FIG. 7 is a block diagram illustrating an example of a multilayer perceptron (MLP) 611 according to one embodiment. MLP 611 can represent the Q network or RL agent of FIG. 6A. In one embodiment, MLP 611 includes an input layer 701, a plurality of fully connected layers 703-705, and an output layer 707. Fully connected layers has connections from every input node of the layer to every output node of the layer. Input layers can correspond to the inputs (e.g., obstacles and vehicle information for a current state of the ADV). Output layer can generate a vector of Q-values corresponding to a vector of actions corresponding to an action space. In one embodiment, MLP 611 includes four fully connected layers. MLP 611 can be used by an RL agent to generate actions (e.g., acceleration/deceleration value and steering angle).

State information includes obstacles information and vehicle information. FIG. 8 is a block diagram illustrating a plurality of rays 805 representative of obstacles information according to one embodiment. Referring to FIG. 8, environment 800 can correspond to a simulation environment for RL training. In one embodiment, ADV 801 is undergoing RL training. ADV 801 can represent ADV 101 of FIG. 1. Referring to FIG. 8, environment 800 can include one or more obstacle vehicles 803. ADV 101 can detect distances to obstacles 803 via rays 805. Rays 805 can correspond to LIDAR/RADAR/time-of-flight sensor values capturing a reflection from obstacle vehicles for ADV 101 in real-time. In one embodiment, rays 805 can include velocity information for detected obstacles. In one embodiment, each of rays 805 can include information such as: be (x, y, sqrt((x−x₀)²+(y−y₀)²), speed), where (x, y) is a coordinate of a detected obstacle, (x₀, y₀) is a coordinate of the ADV, sqrt((x−x₀)²+(y−y₀)²) is a distance from the ADV to the detected obstacle, and speed is an approximate velocity of the detected obstacle. In one embodiment, a quantity of rays 805 is 24, where each ray is approximately 15 degrees angle away from adjacent rays. Although 24 rays is used as the example, the quantity of rays 805 can be any positive integer number, e.g., 4, 8, 12, 48, etc. Furthermore, each ray can have differing angles to adjacent rays. For example, the rays in front of the ADV, behind the ADV, or rays directed towards a target lane can be of different quantities (e.g., a higher quantity towards the target lane than away from the target lane). Using rays 805, an ADV can obtain information about obstacles surrounding the ADV. From the obstacles information and information for ADV 801, a RL model can be applied to these information to generate an action that maximizes a reward.

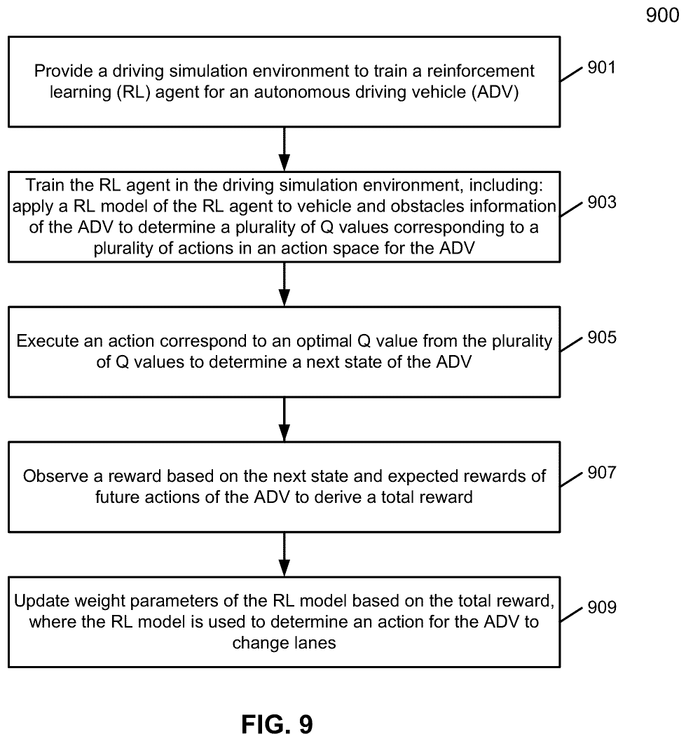

FIG. 9 is a flow diagram illustrating a process to train a ML model using RL according to one embodiment. Process 900 may be performed by processing logic which may include software, hardware, or a combination thereof. For example, process 900 may be performed by ML engine 122 of FIG. 4.

Referring to FIG. 9, at block 901, processing logic provides a driving simulation environment (e.g., environment 601) to train a reinforcement learning (RL) agent (e.g., agent 603) for an autonomous driving vehicle (ADV).

At block 903, processing logic training the RL agent in the driving simulation environment, including: applying a RL model of the RL agent to obstacles information and vehicle information of the ADV to determine a plurality of Q values corresponding to a plurality of actions in an action space for the ADV, where an action comprises acceleration/deceleration value and steering angle.

At block 905, processing logic executes an action correspond to a highest Q value from the plurality of Q values to determine a next state of the ADV.

At block 907, processing logic determines a total reward based on a reward calculated for the next state and a discounted future reward calculated for possible future actions of the ADV.

At block 909, processing logic updates weight parameters of the RL model based on the total reward, wherein the RL model is used to determine an action for the ADV to perform a lane change.

In one embodiment, the obstacles information includes a distance to a vehicle in front of the ADV, a distance to a vehicle behind the ADV, or a length of a gap between two vehicles at the target lane.

In one embodiment, the distance to the vehicle in front of the ADV, a distance to the vehicle behind the ADV, and the length of a gap at the target lane is presented by a plurality of rays of distances from the ADV to one or more obstacles surrounding the ADV.

In one embodiment, a quantity of the plurality of rays is approximately 24 and each ray is separated from adjacent rays by approximately 15 degrees angle.

In one embodiment, the plurality of rays include information correspond to velocities of obstacles detected at the rays.

In one embodiment, the RL model includes a value-based RL model to determine a Q value for each action in a plurality of actions based on the obstacles information and vehicle information.

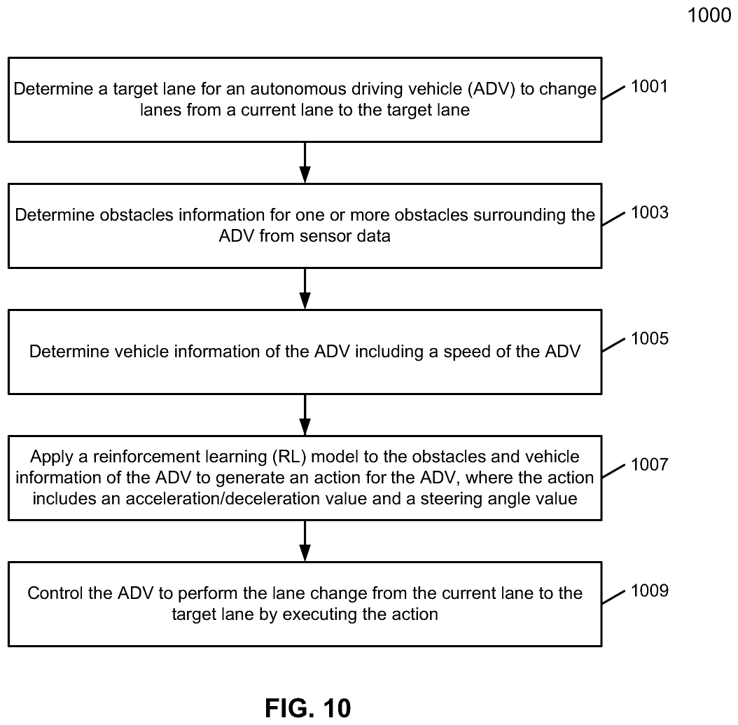

FIG. 10 is a flow diagram illustrating a process to perform a lane change using an RL agent according to one embodiment. Process 1000 may be performed by processing logic which may include software, hardware, or a combination thereof. For example, process 1000 may be performed by lane change module 308 of FIG. 5.

Referring to FIG. 10, at block 1001, processing logic determines a target lane for an autonomous driving vehicle (ADV) to change lane from a current lane to the target lane.

At block 1003, processing logic determines, from sensor data, obstacles information for one or more obstacles surrounding the ADV.

At block 1005, processing logic determines vehicle information comprising a speed of the ADV.

At block 1007, processing logic applies a reinforcement learning (RL) model to the obstacles information and the vehicle information of the ADV to generate an action for the ADV, where the action comprises an acceleration/deceleration value and a steering angle value.

At block 1009, processing logic controls the ADV to perform the lane change from the current lane to the target lane by following/executing the action.

In one embodiment, the obstacles information comprises a distance to a vehicle in front of the ADV, a distance to a vehicle behind the ADV, or a length of a gap between two vehicles at the target lane.

In one embodiment, the distance to the vehicle in front of the ADV, a distance to the vehicle behind the ADV, and the length of a gap at the target lane is presented by a plurality of rays of distances from the ADV to one or more obstacles surrounding the ADV.

In one embodiment, a quantity of the plurality of rays is approximately 24 and each ray is separated from adjacent rays by approximately 15 degrees angle.

In one embodiment, the plurality of rays include information correspond to velocities of obstacles detected at the rays.

In one embodiment, the RL model includes a value-based RL model to determine a Q value for each action in a plurality of actions based on the obstacles information and the vehicle information.

In one embodiment, processing logic generates a next state information for the ADV by executing the action. Processing logic determines a reward based on the next state and expected rewards of future actions of the ADV to derive a total reward. Processing logic stores the vehicle and obstacles information, the action, the total reward, and the next state information for the ADV in a replay buffer, wherein the replay buffer includes a plurality of replay experiences to further train the RL model.

In one embodiment, processing logic periodically trains the RL model using one or more replay experiences from the replay buffer.

In one embodiment, the RL model is trained using deep Q network reinforcement learning that provides a positive reward for successful lane changes.

In one embodiment, the RL model includes a deep Q network and the deep Q network includes a multi-layer perceptron (MLP) neural network model.

In one embodiment, the MLP neural network model includes a plurality of fully connected layers.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method, comprising:
determining a target lane for an autonomous driving vehicle (ADV) to change lanes from a current lane to the target lane;
determining, from sensor data, obstacles information for one or more obstacles surrounding the ADV;
determining vehicle information comprising a speed of the ADV;
applying a reinforcement learning (RL) model to the obstacles information and the vehicle information of the ADV to generate an action for the ADV, wherein the action comprises an acceleration/deceleration value and a steering angle value; and
controlling the ADV to perform the lane change from the current lane to the target lane by executing the action.

2. The method of claim 1, wherein the obstacles information comprises a distance to a vehicle in front of the ADV, a distance to a vehicle behind the ADV, or a length of a gap between two vehicles at the target lane.

3. The method of claim 2, wherein the distance to the vehicle in front of the ADV, a distance to the vehicle behind the ADV, and the length of a gap at the target lane is presented by a plurality of rays of distances from the ADV to one or more obstacles surrounding the ADV.

4. The method of claim 3, wherein a quantity of the plurality of rays is approximately 24 and each ray is separated from adjacent rays by approximately 15 degrees angle.

5. The method of claim 3, wherein the plurality of rays include information correspond to velocities of obstacles detected at the rays.

6. The method of claim 1, wherein the RL model includes a value-based RL model to determine a Q value for each action in a plurality of actions based on the obstacles information and the vehicle information.

7. The method of claim 1, further comprising:
generating a next state information for the ADV by executing the action;
determining a reward based on the next state and expected rewards of future actions of the ADV to derive a total reward; and
storing the vehicle and obstacles information, the action, the total reward, and the next state information for the ADV in a replay buffer, wherein the replay buffer includes a plurality of replay experiences to further train the RL model.

8. The method of claim 7, further comprising periodically training the RL model using one or more replay experiences from the replay buffer.

9. The method of claim 1, wherein the RL model is trained using deep Q network reinforcement learning that provides a positive reward for successful lane changes.

10. The method of claim 1, wherein the RL model includes a deep Q network and the deep Q network includes a multi-layer perceptron (MLP) neural network model.

11. The method of claim 10, wherein the MLP neural network model includes a plurality of fully connected layers.

12. A computer-implemented method, comprising:
providing a driving simulation environment to train a reinforcement learning (RL) agent for an autonomous driving vehicle (ADV); and
training the RL agent in the driving simulation environment, comprising:
applying a RL model of the RL agent to obstacles information and vehicle information of the ADV to determine a plurality of Q values corresponding to a plurality of actions in an action space for the ADV, wherein an action comprises an acceleration/deceleration value and a steering angle value;
executing an action correspond to a highest Q value from the plurality of Q values to determine a next state of the ADV;
determining a total reward based on a reward calculated for the next state and a discounted future reward for possible future actions of the ADV; and
updating weight parameters of the RL model based on the total reward, wherein the RL model is used to determine an action for the ADV to perform a lane change.

13. The method of claim 12, wherein the obstacles information includes a distance to a vehicle in front of the ADV, a distance to a vehicle behind the ADV, or a length of a gap between two vehicles at the target lane.

14. The method of claim 13, wherein the distance to the vehicle in front of the ADV, a distance to the vehicle behind the ADV, and the length of a gap at the target lane is presented by a plurality of rays of distances from the ADV to one or more obstacles surrounding the ADV.

15. The method of claim 14, wherein a quantity of the plurality of rays is approximately 24 and each ray is separated from adjacent rays by approximately 15 degrees angle.

16. The method of claim 14, wherein the plurality of rays include information correspond to velocities of obstacles detected at the rays.

17. The method of claim 12, wherein the RL model includes a value-based RL model to determine a Q value for each action in a plurality of actions based on the obstacles information and vehicle information.

18. The method of claim 12, further comprising:
generating a next state information for the ADV by executing the action;
determining a reward based on the next state and expected rewards of future actions of the ADV to derive a total reward; and
storing the vehicle and obstacles information, the action, the total reward, and the next state information for the ADV in a replay buffer, wherein the replay buffer includes a plurality of replay experiences to further train the RL model.

19. The method of claim 18, further comprising periodically training the RL model using one or more replay experiences from the replay buffer.

20. A non-transitory machine-readable medium having instructions stored therein, which when executed by a processor, cause the processor to perform operations, the operations comprising:
determining a target lane for an autonomous driving vehicle (ADV) to change lanes from a current lane to the target lane;
determining, from sensor data, obstacles information for one or more obstacles surrounding the ADV;
determining vehicle information comprising a speed of the ADV;
applying a reinforcement learning (RL) model to the obstacles information and the vehicle information of the ADV to generate an action for the ADV, wherein the action comprises an acceleration/deceleration value and a steering angle value; and
controlling the ADV to perform the lane change from the current lane to the target lane by executing the action.
